(19) United States
(12) Patent Application Publication
(10) Pub. No.: US 2026/0145617 A1
(43) Pub. Date: May 28, 2026

(54) VEHICLE CARGO RESTRAINT SYSTEM

(71) Applicant: PRIMACY SOLUTIONS, LLC, Earlysville, VA (US)

(72) Inventor: Patrick Hanrahan, Earlysville, VA (US)

(21) Appl. No.: 19/401,218

(22) Filed: Nov. 25, 2025

Related U.S. Application Data
(60) Provisional application No. 63/725,017, filed on Nov. 26, 2024.

(51) Int. Cl. B60R 7/04; B60R 7/08

(52) U.S. Cl. CPC B60R 7/043; B60R 7/08

(57) ABSTRACT

A system comprising a strap and buckle for securing cargo in the passenger compartment of a vehicle.

### CROSS REFERENCE TO RELATED APPLICATIONS

Not applicable

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a strap and buckle system for securing cargo in the passenger compartment of a vehicle.

### Background of the Invention

Various line, strap and container systems for storing and securing cargo in moving vehicles are known. Known systems require the use of either specially designed containers with means of attachment to a vehicle floor or side, such as Velcro, or the use of special points of attachment located on the vehicle itself, such as ratchet strap clips or hooks.

What is needed is a system to secure bags, boxes and other cargo within the passenger compartment of a vehicle to prevent the cargo from sliding and shifting while the vehicle is in motion without requiring specialized containers or the customization of the vehicle to accommodate the system.

### BRIEF DESCRIPTION OF THE DRAWINGS

FIG. 1 shows the components of the inventive system.

FIG. 2A shows the inventive system securing a shopping bag on a vehicle floorboard.

FIG. 2B shows a closeup of the belt of FIG. 2A securing bag handles.

FIG. 3A shows the inventive system using a clipping mechanism securing a bag on a vehicle floorboard.

FIG. 3B shows a close up of the clipping mechanism of FIG. 3A securing bag handles.

### DETAILED DESCRIPTION OF THE INVENTION

The invention comprises a system of one or more strapping devices for attaching to existing equipment within a vehicle, which device(s) can be attached to one or more pieces of cargo or receptacles to prevent the cargo from shifting while the vehicle moves.

Each strapping device comprises a strap, a two-piece buckle and, optionally, one or more fasteners for attaching to the cargo. When the two-piece buckle is closed, the strapping device forms a loop that can be attached both to the cargo and to a piece of equipment attached to the vehicle interior. In a preferred iteration, the strap is attached to the headrest or the metal beams attaching a headrest to a passenger seat.

Further, each strap should be adjustable and sized, together with the buckle, such that the entirety of the strap is held as tightly as possible to the cargo whilst the cargo rests on a horizontal surface, such as a vehicle floor or passenger seat. A loose connection will allow a certain amount of movement in the cargo, which could result in spillage from a receptacle or damage to cargo or the vehicle. Adjustment slides are embodied as commercially known strap adjusters, tri-glides or ladder locks.

The straps can be made of webbing of either natural or synthetic fiber, preferably polyester. Alternatively, the strap could be made of expandable fiber rope such as one or more bungee cords. Each buckle will preferably be a commercially available two-piece, snap-fit buckle with release buttons on either side, that allows for adjustment of the strap length. The buckle is opened or released when pressure is applied to each release button simultaneously. In an alternate embodiment, each buckle comprises a third pressure point or release button in addition to the two side release buttons, so that three points must be pressed to allow the buckle to open. Alternatives to buckles include carabiners, hooks or knots.

In a preferred embodiment, each buckle is constructed of polyoxymethylene (POM), Nylon, PVC, PP, ABS Acetal, aluminum, or a similar commercially available polymer or metal material.

In an alternate embodiment, a cam buckle is used either in addition to or in lieu of the previously described button for improved adjustability of strap length.

In another preferred embodiment, the device further comprises a clip for attachment of the strap to the item to be secured, such clip embodied as a spring-loaded clip, a hook, a pin, Velcro tape, or a similar means of attachment.

When not in use, the entire device can be stored in a seat-back pocket, under a seat, in a door pocket or similar stowage location.

### DETAILED DESCRIPTION OF THE FIGURES

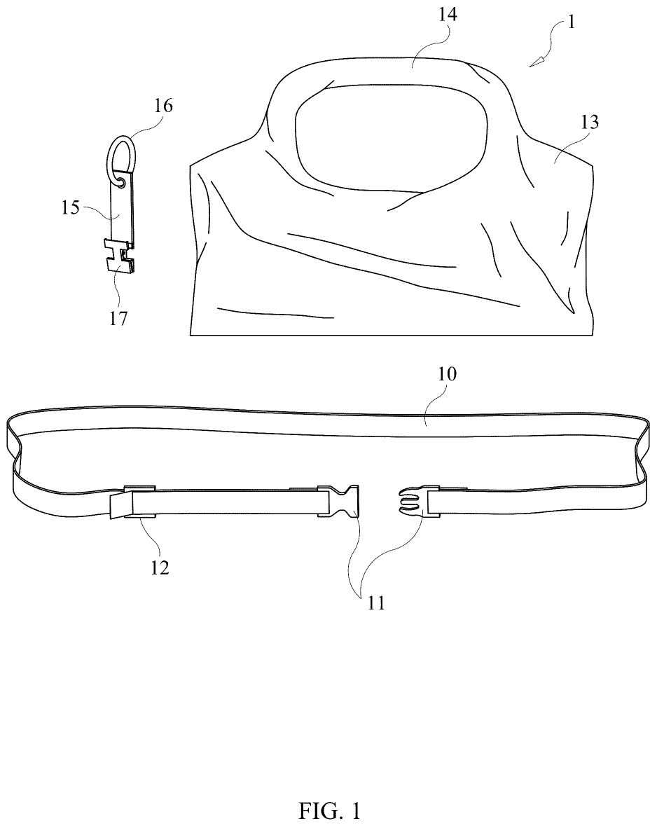

FIG. 1 shows an exploded view of the components of the inventive strapping system components. Strap 10 is overlaid by an adjustment slide 12, allowing the strap to shorten or elongate as needed to keep the strap taught and prevent secured cargo from moving. The strap ends comprise a snap-fig buckle 11. Also shown are an optional clipping mechanism 15 comprising a ring 16 for attachment to the strap and a clip 17 for attachment to secured cargo. Finally, for purposes of illustration, a bag 13 comprising a bag handle 14 are also pictured. In practice, the strap device may be used with any type of cargo, including bags, boxes or other containers or free objects, either using the optional clipping mechanism, when appropriate, or directly securing the cargo with the strap.

The clipping mechanism 15 may alternatively comprise a single clip large enough to overlay the strap and a point of attachment on the cargo or container to be secured. Alternate embodiments of attachment mechanisms may also be employed together with the inventive strap, such as bungee or other cords, hooks, Velcro straps or other, similar mechanisms, wherein the alternate mechanism overlays or wraps around the strap and a component of the cargo or container.

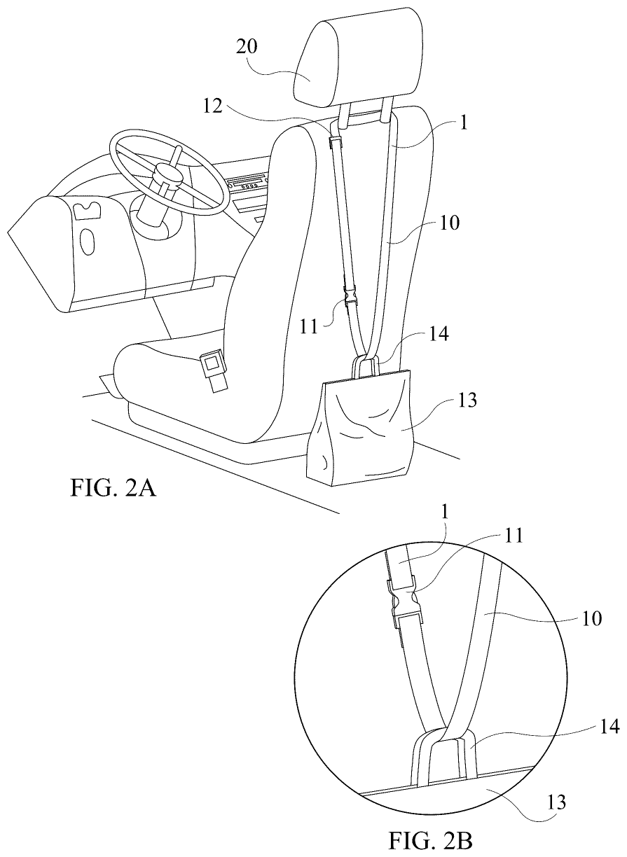

FIG. 2A shows a perspective view of a preferred method of use of the strapping device 1, whereby the strap 10 and buckle 11 form a loop around the lower portion of a vehicle seat headrest 20, wherein the loop extends downward from the back of the seat. The strap is adjusted using adjustment slide 12 to a proper length for maintaining an upward pull on the bag handles 14, while allowing the bag 13 to rest on the floorboard of the vehicle. The strapping device simultaneously holds the bag in place on the floorboard and holds the upper portion of the bag closed to prevent spillage. In an alternate embodiment, the cargo is placed on a vehicle seat rather than a floorboard.

FIG. 2B shows a close-up view of the interaction of the belt 10, looped with the belt clip 11, through bag handles 14.

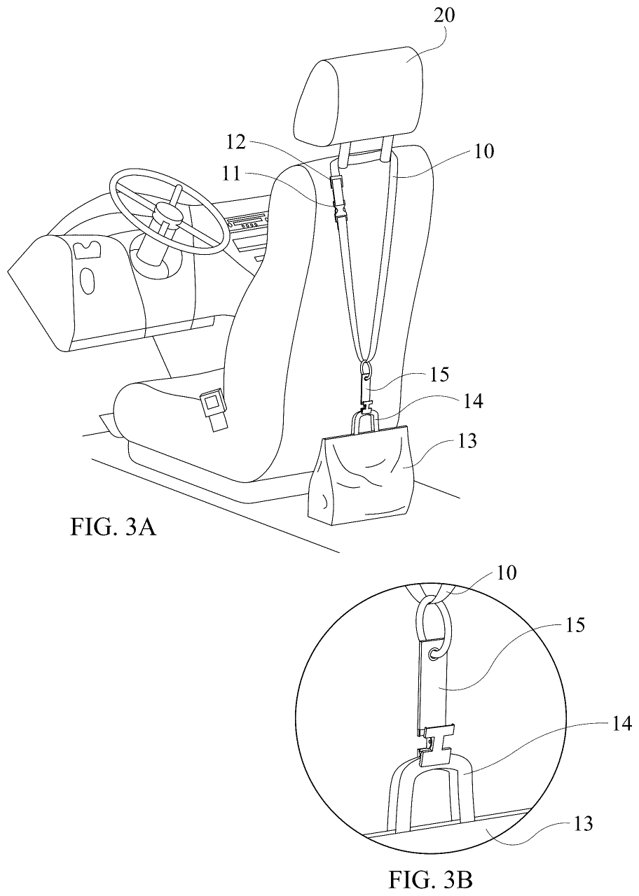

FIG. 3A shows an alternate use method, wherein clip mechanism 15 is employed so that belt 10 threads through ring 16, while clip 17 secures the bag handles 14. Again, the belt is looped using buckle 11, hung about vehicle seat headrest 20 and the belt length is adjusted with adjustment slide 12 to keep the bag 13 motionless on the floorboard of the vehicle.

FIG. 3B shows a close-up view of the interaction of the belt 10, clipping mechanism 15 and the bag handles 14 to ensure a dependable hold against movement of the cargo bag 13.

The strapping devices as pictured may be used alone or in combination with one or more additional strapping devices. For example, larger or heavier cargo sitting in the rear of a SUV or pickup truck may be best secured with points of attachment to two headrests or other fixed points of attachment in the vehicle interior, using two belts to effect such attachments.

### PARTS LIST

1 Strapping device
10 Strap
11 Buckle
12 Adjustment slide
13 Bag
14 Bag handle
15 Clipping mechanism
16 Ring
17 Clip
20 Headrest

Unless indicated otherwise, any cross-references to the figure components identify identical components with the same function.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A system for securing cargo or a receptacle in a moving vehicle, comprising one or more strapping devices, each device comprising:
a strap;
a two-piece buckle attached to either end of the strap; and
optionally, a clipping mechanism;
wherein the one or more strapping devices are employed by the following steps:
looping the one or more strapping devices around a fixed component of the vehicle interior;
looping the strapping device around the cargo or receptacle, through an aperture in the cargo or receptacle, or clipping the strapping device to the cargo or receptacle;
closing the buckle; and
adjusting the length of the strap such that the cargo or receptable is held tightly on a horizontal surface.

2. The system of claim 1, wherein each strap is sized such that the strapping device exerts a slight upward pressure on the cargo or receptacle.

3. The system of claim 1, wherein the fixed component of the vehicle interior is a seat headrest.

4. The system of claim 1, wherein the belt is adjusted using a tri glide.

5. The system of claim 1, wherein each buckle is constructed of polyoxymethylene (POM), Nylon, PVC, PP, ABS Acetal, aluminum, or a similar commercially available polymer or metal material.

6. The system of claim 1, wherein the straps are comprised of webbing of either natural or synthetic fiber, preferably polyester.

7. A method of use of the one or more strapping devices of claim 1, comprising the steps of:
Securing the strap to a fixed component of the vehicle interior;
Securing the strap to a piece of cargo or receptacle;
Adjustably tightening the strap to maintain a tight connection between the cargo or receptacle and the fixed component of the vehicle interior.

8. The method of claim 7, wherein the piece of cargo or receptacle is secured to the strap using a clipping mechanism.

9. The method of claim 7, wherein the strap is looped through or clipped to the handles of a bag containing cargo such that the tightening of the strap both fixes the bag on a horizontal surface and closes the handles of the bag to prevent spillage.

10. The method of claim 7, wherein the fixed component of the vehicle interior is a seat headrest.

11. The method of claim 7, wherein the piece of cargo or receptacle is seated on the vehicle floorboard.

12. The method of claim 7, wherein the piece of cargo or receptacle is seated on a vehicle seat.
